(19) United States
(12) Patent Application Publication
(10) Pub. No.: US 2003/0044320 A1
(43) Pub. Date: Mar. 6, 2003

(54) High throughput screening micro array platform

(76) Inventor: Shun Luo, Irvine, CA (US)

Correspondence Address: DEVINE, MILLIMET & BRANCH, P.A., 111 AMHERST STREET, BOX 719, MANCHESTER, NH, 03105, US

(21) Appl. No.: 09/943,937

(22) Filed: Aug. 31, 2001

(51) Int. Cl. G01N 21/03; G01N 21/01

(52) U.S. Cl. 422/65; 422/100; 422/102

(57) ABSTRACT

The present invention discloses platform technology which integrates current DNA micro array technology and current high throughput screening technology. The invention contains three major components: an array gridding head, the hybrid glass chip/micro titer plate format plate that contains the micro arrays produced by the arraying/gridding head, and an array scanner with data acquisition and analysis software. The arraying/gridding head is capable of simultaneously depositing DNA, RNA peptidalnucleic acid (PNA), or polypeptide (protein) solutions, etc. onto chemically treated modified surfaces in 96, 384 and 1536 well formats of repeating patterns on the modified glass chips/plates. The micro arrays are composed of arrays of 96, 384 or 1536 patterns with defined specifications on the single glass “chip” packaged as a standard micro titer plate conforming to the Society of Biomolecular Screening (SBS) specification for robotic handling. The array reading and analysis component includes an array scanning device and analysis software. The array scanner is configured to read micro arrays in the micro titer plate format of the invention as well as current microscope slide format. Thus, the invention transforms current DNA micro array technology into a high throughput screening tool.

### FIELD OF THE INVENTION

The invention relates generally to micro array technology and high throughput screening. More particularly, the invention relates to the combination or hybridization of micro array technology and a high throughput platform. Most particularly the system and method enable one to do DNA micro array screening in a high throughput screening format. The present invention is particularly useful to simultaneously create a series of micro arrays, each comprising hundreds or thousands of analyte-assay regions on a solid support in the form or footprint of a standard micro titer plate, thus combining the two technologies and enabling the screening of much greater numbers of DNA micro arrays than currently possible, using the standard micro titer plate format in a high throughput system.

### BACKGROUND OF THE INVENTION

The relationship between structure and function of molecules is a fundamental issue in the study of biological and other chemical based systems. Structure-function relationships are important in understanding many biological interactions, such as, for example, the function of enzymes, cellular communication, and cellular control and feedback mechanisms. Certain macromolecules are known to interact and bind to other molecules having a specific three-dimensional spatial and electronic distribution. Any macromolecule having such specificity can be considered a receptor, whether the macromolecule is an enzyme, a protein, a glycoprotein, an antibody, and oligonucloetide sequence of DNA, RNA or the like. The various molecules to which receptors bind are known as ligands.

Pharmaceutical drug discovery is one type of research that relies on the study of structure-function relationships. Much contemporary drug discovery involves discovering novel ligands with desirable patterns of specificity for biologically important receptors. Thus, the time to bring new drugs to market could be greatly reduced through the use of methods and apparatus which allow rapid generation and screening of large numbers of ligands.

DNA Micro Array

One method of screening is DNA micro array technology. Current DNA micro array technology is focused on high-density DNA depositions on two major substrates: 1.) glass microscope slide, and 2.) nylon or nitrocellulose membrane.

Micro arrays of hundreds or thousands of biological analyte-assay regions are widely used for biological analysis. Currently DNA chips and micro arrays are being used for gene expression analysis, gene discovery, gene mapping, genotyping, mutation detection including single nucleotide polymorphism (SNP) detection. The range of applications for DNA chips and micro array technology is growing fast and spreading into such areas as clinical diagnostics, food safety testing, and forensic study to name but a few.

Most basically the micro arrays are DNA samples immobilized onto glass. Usually tens up to hundreds of thousands of DNA fragments are put onto an approximately 2 cm square area of glass surface treated with various chemicals. In general there are three different kinds of DNA chips/micro arrays. These are: cDNA arrays, arrays constructed using pre-made oligonucleotides, and arrays constructed using in-situ synthesized DNA. Tiny droplets, each containing a different known reagent, usually polynucleotide or polypeptide biopolymers such as known DNA fragments, cDNA (which are relatively long strands of DNA representing pieces of genes) or short oligonucleotides (which are usually about 20-70 bases long), are deposited and immobilized in a regular array on a solid substrate such as a glass microscope slide. This kind of micro array is usually fabricated in two major forms. One form is by synthesizing oligonucleotide sequences directly on a solid phase using photolithographic technology such as the VLSIPS TM technology. The other is by depositing DNA fragments in form of oligonucleotides, PCR amplification products, or plasmid DNA of complementary DNA (cDNA) clones.

The glass substrate is almost in all cases in microscope slide format. The immobilization of DNA samples onto the glass can be via covalent or non-covalent bonding. These DNA slides are used to allow hybridization on the surface of the glass between the immobilized samples and the DNA or RNA being tested. Micro array assays are designed to give qualitative and quantitative genetic information concerning the tested samples. “DNA chips” is usually used to refer to the high density oligonucleotide arrays generated by in-situ methods and the term “DNA micro arrays” is used to refer to the low and medium density cDNA or Oligonucleotide arrays generated by microspotting DNA samples onto glass.

The array of dried droplets is exposed to a solution containing an unknown, for example complementary DNA (cDNA) fragments pre-labeled with fluorescent or radioactive chemical tags. Binding reactions or hybridizations occur wherever there is a match between the complementary sequence polynucleotides in the array and the cDNA. Subsequent optical or radiosensitive scanning determines which spots contain tags, thereby identifying the complementary compounds present in the solution. The choice of tag, for example fluorescent dye, used in the micro array procedures is largely determined by the instrumentation that is used to detect the fluorescence generated.

As noted above, the arrays are typically deposited on a solid substrate, commonly a glass microscope slide. Thus, the number of arrays per slide is limited by the size of a common microscope slide. It has proven difficult to handle a high volume of such glass microscope slides using current automation platforms. However, glass is preferred due to the fact that many of the micro array assays are fluorescence assays using very small amounts of the compounds, and the low background fluorescence of glass is needed. Thus, while it is of great value to study tens of thousands of genes involved in any complex biological process and regulation, and gain tremendous insights into our understanding of biological and pathological occurrences, it is challenging to screen large numbers of biological, physiological, and pathological conditions simultaneously with the current DNA micro array.

Practically, current microscope slide format of DNA micro array is not suitable to automated technology platforms that are used to screen drug or clinical samples. The microscope slides are small (about 1 inch×3 inches), fragile and hard to handle en masse. In addition, a typical microscope slide can only hold an array of about 100×100 samples. Thus, while micro arrays provide a useful tool for relatively rapid biological analysis, the processes by which the micro arrays are produced and later read, and the materials on which they must be produced and read, remain time consuming, expensive and limited in their number and size.

High Throughput Screening

Another method of screening biological and chemical compounds is high throughput screening (HTS). With HTS, multiple samples or analytes can be assayed or analyzed at one time. High throughput screening is typically used for detecting the effect of a given compound or treatment on cell metabolic activity. With the advent of combinatorial library methods for generating large libraries of compounds, there has been a growing interest in high throughput screening (HTS) methods for screening such libraries. In addition, as we have achieved the near completion of human and other organism genome sequencing projects, the so-called post genome era has come. A most challenging question now is how to utilize such high volume information to benefit drug discovery and clinical diagnosis. When screening for specific therapeutics or diagnosing clinical samples, a specific molecular target is identified and applied for reasons of being relevant to biology and pathology.

For example, Viagra™ was screened as a therapeutic using one enzyme target that is relevant to penile muscle contraction. However, Viagra™ is not completely specific to penile muscle due to the screening process of using one isolated target, Phosphodiesterase V, which is expressed not just in penis, but also other tissues such as the cardiovascular system. To gain such penile specificity, more penile factors, or molecules that are both specific to the muscle and to the penile regulation mechanism are required in screening. Such multifactor screening will maintain the effectiveness of such therapeutics and eliminate any adverse effect on other parts of the body. The challenge is how to integrate such complex information and requirements into high throughput screening platforms.

The most widely used HTS method involves competitive or non-competitive binding of library compounds to a selected target molecule. Such screening is typically done in multi-well platforms. These multi-well platforms are particularly useful for fluorescence measurements of chemical or biological samples. Typically these multi-well platforms are also in the form of micro titer plates having 96 wells. The footprint of such an industry standard multi-well plate is typically about 85.5 mm in width by about 127.5 mm in length. These plates can have 96 wells or multiples of 96 well, including 364, 864, 1536, 3456 or 9600 wells. A variety of micro titer plates are commercially available for culturing cells, storing compounds, or performing chemical or cellular assays. While many of these multi-well plates offer the desirable features of biocompatibility, ease of manufacture, and substantial structural integrity, these plates, especially those with polymeric bottoms, suffer from a relatively high amount of background fluorescence. This high background fluorescence makes such plates generally not suitable for highly sensitive fluorescence measurements associated with many assays, particularly those using micro-liter volumes or less.

An alternative plate material is glass, which has very low background fluorescence. However, glass can not be injection molded, and it is extremely difficult to form glass into a 96 well plate, much less a 9600 well plate.

Thus it would be desirable to be able to integrate DNA micro array technology and high throughput screening in a platform that is both easy to manufacture, and work with. Such a hybrid platform would include a DNA micro array glass platform in the form of a standard micro titer plate for use in a high throughput screening format.

### SUMMARY OF THE INVENTION

The present invention includes a DNA micro array platform that provides a focused number of target genes that are specific to pathways of interest in high throughput drug screening. The platform of the invention maintains has multifactor screening capability and transforms the current DNA micro array technology into a high throughput screening tool. The invention integrates the current genomics DNA micro array and high throughput drug screening technologies. It transforms the DNA micro array format from microscope slide to a widely accepted micro titer plate format, i.e. 96, 384, 1536, etc. The invention is useful for drug screening, genotyping, and diagnostic applications in a large-scale or clinical setting. The current DNA micro array technology is simply not useful for large-scale, high throughput screening. The present invention can screen or handle about 96 times more samples then current DNA micro array techniques, while using the same, conventional robotic technology.

The invention has three major components: an array gridding head, the micro titer plate format hybrid glass chip/micro titer plate onto which the arrays are deposited, and an array scanner or reader.

The arraying/gridding head has components with the capabilities of simultaneously depositing DNA, RNA peptidalnucleic acid (PNA), or polypeptide (protein) solutions, etc. onto chemically treated modified surfaces in 96, 384 and 1536 well formats of repeating patterns on modified glass/plastic micro titer plates. The second component is composed of a single glass “chip”, or hybrid micro titer plate, packaged as a standard micro titer plate conforming to the Society of Biomolecular Screening (SBS) specification for robotic handling. Onto the hybrid chip/micro titer plate are deposited micro arrays of 96, 384 or 1536 patterns with defined specifications. The arrays produced may be square or non-square arrays of any size between the minimum and maximum array size for each format of number of wells. The array reading or analysis portion includes an array scanning device and analysis software. The array scanner is configured to read a micro array in micro titer plate format as well as current microscope slide format.

Thus one aspect of the invention is to provide a format that integrates the current DNA, RNA, PNA, or protein micro array technology with high throughput drug screening technology.

Another aspect of the invention is to provide DNA, RNA, PNA, or protein micro arrays in a modified glass micro titer plate format for use with high throughput screening techniques.

An additional aspect of the invention is to provide a device capable of depositing DNA, RNA, PNA, or protein micro arrays, square or non-square, on a modified glass micro titer plate.

Yet another aspect of the invention is to provide a modified glass micro titer plate on which DNA, RNA, PNA, or protein micro arrays may be deposited, and which conforms to the Society of Biomolecular Screening (SBS) specification for robotic handling.

A further aspect of the invention is to provide a DNA, RNA, PNA, or protein micro array fluorescence scanner/reader capable of reading DNA, RNA, PNA, or protein micro array results presented in standard micro titer plate format as well as DNA, RNA, PNA, or protein micro array results presented in current, conventional microscope slide format.

A further aspect of the invention is to provide a less expensive, less limiting and less time consuming method of performing DNA, RNA, PNA, or protein micro array analysis for large-scale drug screening, genotyping and clinical diagnostic use.

These and other advantages of the present system will become apparent upon examination of the accompanying Figures and detailed description of the invention.

### BRIEF DESCRIPTION OF THE DRAWINGS

FIG. 1 is a top view showing an overview of the hybrid chip/micro titer plate of the present invention.

FIG. 2 is a side view showing a schematic illustration of a 384 well hybrid chip/micro titer plate.

FIG. 3 is a top view illustrating the arraying head/gridding head in 96 well format.

FIG. 4 is side view illustrating the arraying head/gridding head in 96 well format.

FIG. 5 is a top view illustrating the arraying head/gridding head in 384 well format.

FIG. 6 is a side view illustrating the arraying head/gridding head in 384 well format.

FIG. 7 is an enlargement of the arraying/gridding head showing use of springs to stabilize the pins.

FIG. 8 a table illustrating the minimum and maximum preferred array sizes for various well formats.

### DETAILED DESCRIPTION OF THE INVENTION

Referring now to the figures, in which like reference numerals refer to like elements throughout, the invention is described in detail below. Most basically, the invention integrates the current DNA, RNA, PNA, or protein micro array and high throughput drug screening technologies. It transforms the DNA, RNA, PNA, or protein micro array format from microscope slide (each slide of which can only hold an array of about 100×100 samples) to a widely accepted micro titer plate format, i.e. 96, 384, 1536, etc. (each individual well of which can hold an array of at a minimum 2×2 samples, and up to a maximum array of about 75×75 samples). The invention has three major components: an array gridding head; a hybrid glass chip/micro titer plate format substrate which holds DNA, RNA, PNA, or protein micro arrays produced therein by the gridding head, and an array scanner or reader. The present invention may be used for a variety of applications for which conventional DNA, RNA, PNA, or protein micro array techniques are used, but also provides much higher throughput capability and thus is useful for much larger scale applications including drug screening, genotyping and diagnostics in a clinical setting. Current DNA, RNA, PNA, or protein micro array technology simply can not handle enough samples to be a clinically useful tool. Further examples of types of materials that may be studied and applications for which the present invention provides advantageous uses may be found in U.S. Pat. No. 5,556,752, the specification of which is incorporated herein by reference.

FIG. 1 shows an overview of a hybrid chip/micro titer plate of the present invention. In this particular example, hybrid chip/micro titer plate 10 is shown in 384 well format with wells spaced with standard 4.5 mm pitch center. Wells 12 of chip/plate 10 are shallow and glass bottomed, and chip/plate 10 has the “footprint” or size and shape for standard Society of Biomolecular Screening (SBS) specifications for robotic handling. Also shown, enlarged, is an example of a DNA micro array 14 in a well location 12. In practice there may be a different DNA micro array 14 in each well 12 of chip/plate 10. The DNA micro arrays 14 may be any size between the minimum and maximum array size for a given well format.

For example, see FIG. 8 row 28. The preferred minimum array density for a 96 well format is about 10×10, and the maximum is about 75×75 with any density array in between possible, including non-square arrays. For example a 50×65 array can be made, or a 21×57 array if desired. In the particular example shown in FIG. 1, the array 14 is shown as a 14×14 array. The arrays may contain simultaneously deposited DNA, RNA, peptidalnucleic acid (PNA), polypeptide (protein) solutions or any type of protein, amino acid, or oligonucleotide desired to be studied. Various types of known assays, including all types of analysis currently possible with DNA micro array technology, may be performed using the present invention. The arrays may be constructed in any number of known ways, including photolithographic—for example the VLSIP TM technique, or other techniques, various examples of which may also be found in U.S. Pat. No. 5,556,752 which has been herein incorporated by reference, for background, and general definition of DNA micro array technology and its usefulness and application.

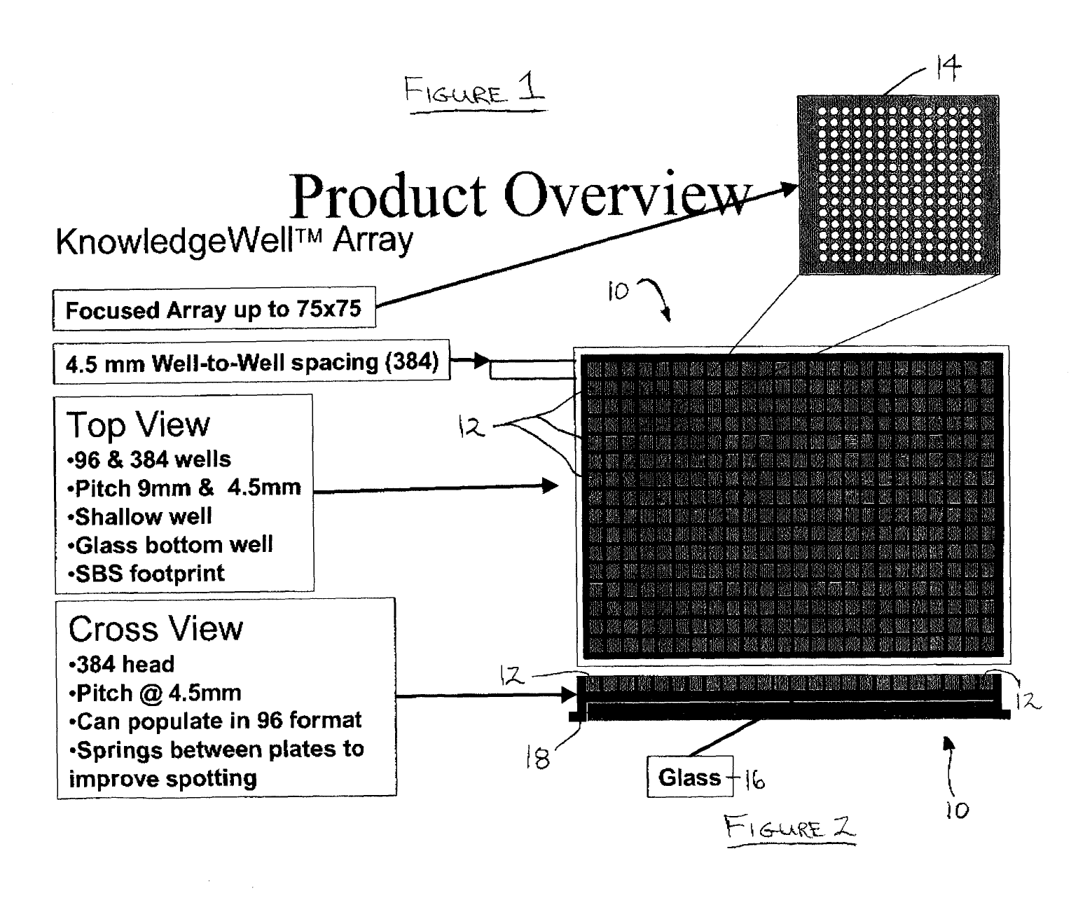

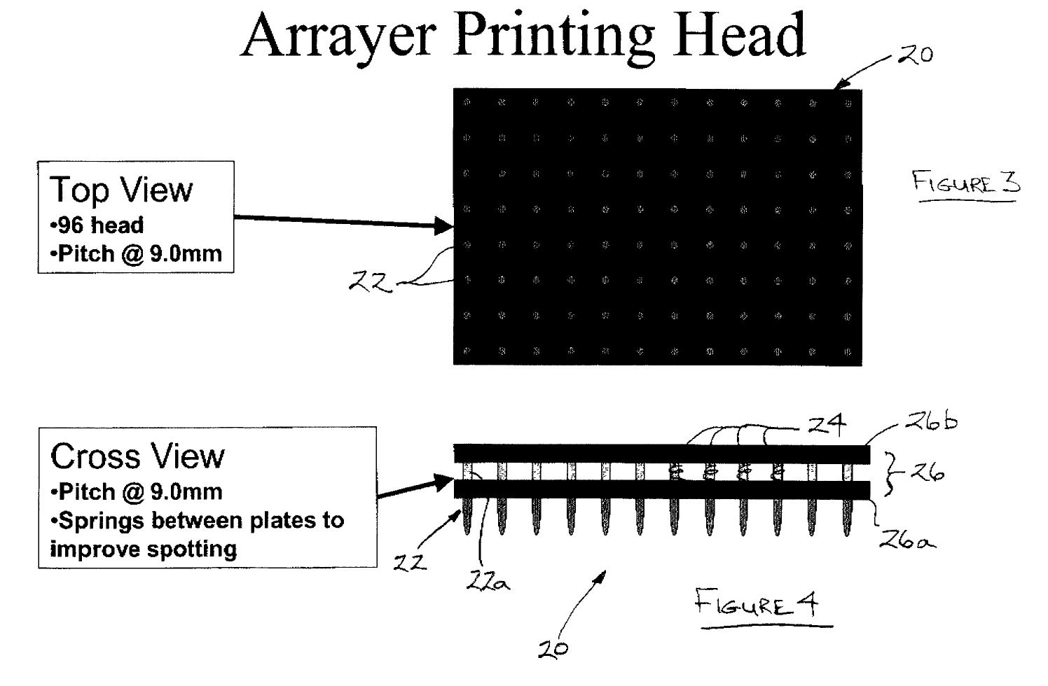

FIG. 2 is a side view of chip/plate 10, again in 384 well format. Such a chip/plate may have 384 arrays deposited therein.

Also shown in FIG. 2 is the composition of chip/plate 10 wherein chip/plate 10 is formed from a combination of glass and plastic. There is glass portion 16 as the top or upper portion of chip/plate 10 in which are formed wells 12. Attached to the bottom of glass portion 16 is plastic support portion 18 which together form completed chip/plate 10. Glass portion 16 and plastic support portion 18 may be any standard formulation or type of glass and plastic commonly used in scientific/biological laboratories. An adhesive, which not be seen in Figures, is used to attach glass portion 16 and plastic support portion 18 to each other. The adhesive is preferably one that will not break down, leak or otherwise fail at temperatures in the range of about 0-100 (zero to one hundred) degrees C, the temperature conditions under which the DNA micro array assays and other bioassays are often carried out. The adhesive should also be resistant to, and not fail under, the acidic and basic solutions and conditions under which micro array assays and other bioassays are performed. Those of skill in the art will know the typical pH ranges and solutions used in micro array assays and other bioassays. A preferred example adhesive may be silica caulk.

As disclosed, chip/plate substrate 10 is preferably in the form of 96, 384 or 1536 well format, and has the footprint of a standard micro titer plate that conforms to the Society of Biomolecular Screening (SBS) specifications for robotic handling. Chip/plate 10 is a hybrid glass chip/micro titer plate which contains separate wells capable of holding volumes of solutions from about 1 ul to about 100 ul. Chip/plate 10 and the micro array(s) contained therein are capable of being sealed by conventional techniques including adhesive or heat sealing. Chip/plate 10 (with SBS-required skirting) conforms to SBS standards of 9 mm pitch centers for 96 well formats, 4.5 mm pitch centers for 384 well formats and 2.25 mm pitch centers for 1536 well formats. Thus, chip/plate 10 carrying its micro arrays allows for robotic handling in high throughput screening platforms. The well designs of all formats described above are preferable square in shape, but may be any usable shape. The plate design of chip/plate 10 allows for stacking of chips/plates 10 with or without lids. Additionally, the glass portion 16 of chip/plate 10 may be treated with specific chemical modifications or conventional/generic treatment for efficient attachment of the DNA, RNA, PNA, or, protein, etc. samples.

FIG. 3 is a top view showing arraying head/gridding head 20 in 96 well format with pins 22 spaced at 9.0 mm. The footprint of head 20 would be that of a standard 96 well micro titer plate. Head 20 holds pins 22 designed to deposit each sample of each array at about 100 ul of sample. Gridding head 20 fills the glass bottomed wells 12 with arrays of sample, and, as noted above, glass substrate hybrid chip/plate 10 may be treated as needed, for example by compounds and methods such as those disclosed in U.S. Pat. No. 5,556,752 which has been incorporated herein by reference, or by any known methods to bind the sample in place on chip/plate 10. In order to construct each array, the pins 22 are washed between each spotting of sample. The whole head 20 is washed between each plate filled. See FIG. 8 for the minimum and maximum preferred array densities for 96 well formats.

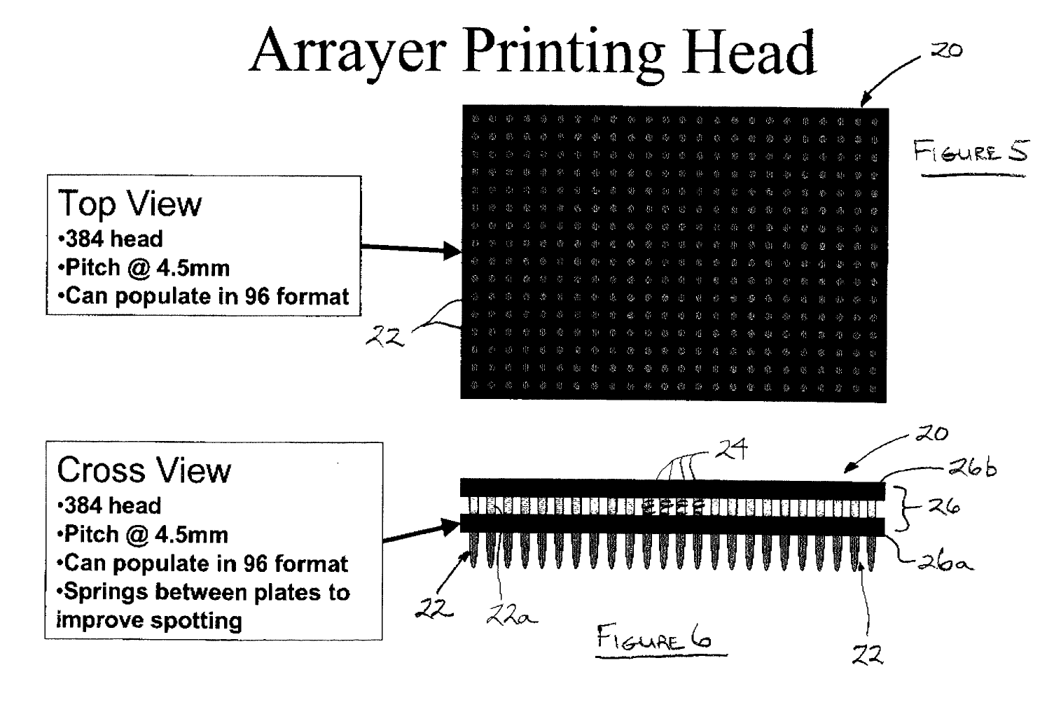

FIG. 4 is a side view of arraying/gridding head 20 and pins 22 illustrating the format of head 26 and showing at least one spring 24 used in arraying/gridding head 20 to facilitate and improve spotting/depositing of sample in each well. Springs 24 help to stabilize pins 22 for more consistent sample deposition. Although FIGS. 3 and 4 illustrate 96 pins, a 96-pin arraying/gridding head may be used to fill chips/plates 10 with larger numbers of wells. For example, a 96-pin arraying/gridding head 20 could be used to fill a 384 well chip/plate 10.

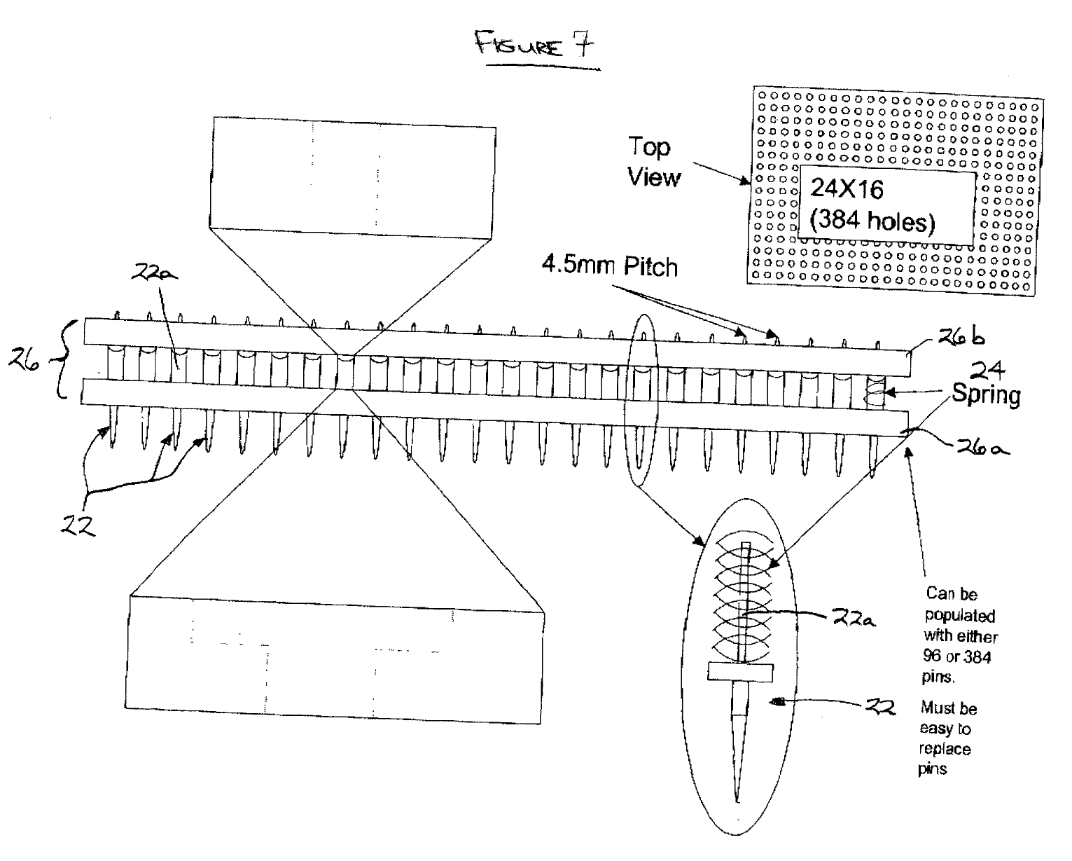

FIG. 5 is a side view similar to FIG. 3, but showing head 20 and pins 22 in a 384 well format. With this format arrays may be made in chip/plates 10 having 384 wells. See FIG. 8 for the minimum and maximum preferred array densities for 384 well formats.

FIG. 6 is similar to FIG. 4 but illustrates schematically head 20 and pins 22 in 384 well format. Again at least one spring 24 may be used in arraying/gridding head 20 to facilitate and improve spotting/depositing of sample in each well. Although FIGS. 5 and 6 show a 384-pin arraying/gridding head 20, a 384-pin arraying/gridding head 20 may be used to fill larger numbers of wells, for example 1536 wells. While 96 and 384 well formats are illustrated specifically in Figures, other numbers of well formats are possible including 1536 well formats. In addition, although not shown, it will be known to one of ordinary skill in the art that the arraying/gridding head 20 may be made with any desired number of pins for filling any number of wells.

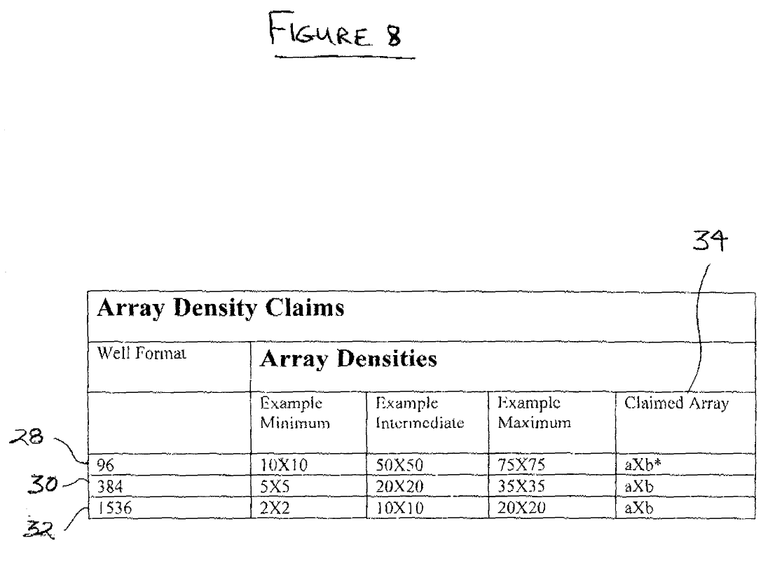

FIG. 7 is a more detailed view of arraying/gridding head 20 which comprises in part a two-layer pin holding device 26. In this particular example a 384 pin format is shown with a spring 24 illustrated enlarged. Preferably the two-layer device 26 has two preferably metal plates-lower plate 26a and upper plate 26b spaced a distance apart. Although metal is the preferred material for lower and upper plates 26a and 26b other materials capable of providing the necessary stability for pins 22 may be used. The shaft 22a of each pin 22 passes through lower plate 26a and is held in place there. Only the tips of pins 22 protrude below lower plate 26a. A spring 24 is disposed about the shaft 22a of each pin 22, between plates 26a and 26b, to provide flex such that the touch of each pin 22 to a surface is even and controlled. Springs 24 facilitate and improve the spotting/depositing of sample into wells. Springs 24 stabilize the shaft 22a of pins 22 such that springs 24 help to hold pins 22 steady when pins 22 touch the glass (or any) surface of a well or other substrate. In combination with two-layer pin holding device 26 springs 24 stabilize each pin 22 so the pins do not slip forward, back or side to side when depositing sample. Therefore sample solution spotted on a surface with arraying/gridding head 20 and its stabilized pins 22 will be more consistent in size and can be deposited in a more controlled manner. “Standard” micro arraying pins which are commercially available for creating micro arrays may be used with arraying/gridding head 20. However, the invention also includes pins 22 specially designed to fit gridding head 20 and that are designed to accurately and reproducibly deposit samples of about 100 ul. Thus it is preferable to use pins 22 that are made for gridding head 22 as opposed to various commercially available DNA micro array pins.

The distance between plates 26a and 26b, and therefore the length and strength of springs 24 is adjusted based on the number of pins or wells to be filled, the material of plates 26a and 26b, the material of the pins, etc., such that optimum stabilization of the pins 22 and optimum consistency of sample deposition amount and size is achieved.

FIG. 8 is a table showing examples of the type and density of DNA micro array per well of micro titer plate formats of varying numbers of wells usable with the present invention. For example, as noted above in row 28 a 96 well format is shown with three example densities of micro array that could be used with the 96 well format. Row 30 illustrates three example densities of micro array for use with a 384 well format. Finally row 32 illustrate three example densities of micro array for use with a 1536 well format. Column 34 illustrates that the arrays may be of any number and shape, square or non-square, within the minimum and maximum optimal densities shown in rows 28, 30 and 32. Numbers “a” and “b” represent array dimensions and are preferably any number between about 2 and 100. Numbers “a” and “b” may be the same-i.e. a square array, or, may be different—i.e. a non-square array. For example 15×20, 74×65, or even 31×47 arrays can be made.

Although not shown, the scanner/reader of the present invention consists of 5 major components and is capable of reading either conventional DNA micro array microscope slide platforms (1 inch by 3 inches) or the hybrid chip/micro titer plate format of the present invention. The 5 components of the reader are: a light source for exciting a tag or other light-reactive substance for detection, an inverted microscope, a photomultiplier tube (PMT) and/or charge coupled device (CCD), a precision 3 dimension XYZ-stage positioning device, and finally, software for real-time data acquisition, processing and analysis in all compatible formats.

In summary the invention provides a way to do DNA (or other) micro array analysis in much greater volume, much more quickly. The arraying/gridding head 20 may contain 96, 384 or 1536 individual gridding pins 22 and may be used for depositing for example deoxyribonucleic acid (DNA), ribonucleic acid (RNA), protein (including oligopeptides), polypeptidal nucleic acid (PNA), protein, amino acid, etc. in square or non-square arrays on to the glass bottomed wells 12 of the hybrid glass chip/plate substrate 10. Chip/plate 10 is formed of an upper glass portion 16 and a lower plastic portion 18 attached together by an adhesive and may be treated with specific chemical modification or generic treatment for example to facilitate binding of the sample to the substrate. Chip/plate 10, and arraying/gridding head 20 with individual gridding pins 22 conform to SBS specifications of 9 mm pitch centers for 96 well format, 4.5 mm pitch centers for 384 well format, and 2.25 pitch centers for 1536 well format. Thus, DNA micro array assays may now be performed in a high throughput format, thus allowing DNA micro array technology to be used for larger scale, clinical applications that are to date not feasible with DNA micro array technology.

While the invention has been described with reference to a preferred embodiment, the foregoing description is illustrative only, and does not limit the scope of the invention. Those of ordinary skill in the art will see that there are possible variations in the structure and function of the system that do not depart from the spirit and scope of the invention and are thus encompassed by the foregoing description.

Accordingly, what is claimed is:

1. A hybrid micro array substrate comprising: a glass substrate portion shaped and formed with a plurality of wells in a 96, 384 or 1536 well micro titer plate format attached to a plastic support portion thereby forming said hybrid substrate.

2. The hybrid micro array substrate of claim 1 wherein said hybrid substrate conforms to SBS size and shape specifications for robotic handling of micro titer plates.

3. The hybrid substrate of claim 1 wherein said glass portion and said plastic support portion are attachable each to the other by adhesive.

4. The hybrid substrate of claim 3 wherein said adhesive is able to withstand acidic and basic assay conditions as well as temperatures from about 0-100 degrees C. without failing.

5. The hybrid substrate of claim 1 wherein said wells are square in shape.

6. The hybrid substrate of claim 1 wherein said wells hold sample volumes in the range of from about 1 ul to about 100 ul.

7. The hybrid substrate of claim 1 wherein each said well contains at least one micro array.

8. The hybrid substrate of claim 1 wherein each said hybrid substrate containing said at least one micro array is sealable by adhesive or heat sealing, and is stackable with or without a lid.

9. The hybrid substrate of claim 7 wherein a minimum density for a micro array in each said well of a hybrid micro titer plate substrate in 96 well format is about 10×10, an intermediate array density is about 50×50 and a maximum array density is about 75×75, and wherein said micro array may be formed in any density, square or non-square, including and between said minimum density and said maximum density.

10. The hybrid substrate of claim 7 wherein a minimum density for a micro array in each said well of a hybrid micro titer plate substrate in 384 well format is about 5×5, an intermediate array density is about 20×20 and a maximum array density is about 35×35, and wherein said micro array may be formed in any density, square or non-square, including and between said minimum density and said maximum density.

11. The hybrid substrate of claim 7 wherein a minimum density for a micro array in each said well of a hybrid micro titer plate substrate in 1536 well format is about 2×2, an intermediate array density is about 10×10 and a maximum array density is about 20×20 and wherein said micro array may be formed in any density, square or non-square, including and between said minimum density and said maximum density.

12. The system of claim 1 wherein said gridding head comprises: an at least two-layer pin holding device comprised of a lower and an upper plate, wherein said gridding pins pass through said lower plate and are held in place by said lower and upper plates wherein only the tips of said gridding pins protrude below said lower plate.

13. The hybrid substrate of claim 12 wherein at least one spring is disposed between said lower and upper plates, and around each said pin such that the combination of said lower and upper plates and said at least one spring of said gridding head stabilizes said pins and provides flex for consistent deposition of sample when said pins contact said hybrid substrate.

14. The hybrid substrate of claim 12 wherein said lower and said upper plates are formed of metal.

15. A system for producing and reading micro arrays in micro titer format comprising:
a gridding head with gridding pins for depositing and creating at least one micro array;
a hybrid chip micro titer plate substrate on which at least one micro array is deposited by said gridding head and on which an assay is performed; and
an array reader which reads and analyzes results of said assay on said hybrid chip micro titer plate substrate.

16. The system of claim 15 wherein said gridding pins of said gridding head are arrangeable in 96, 384 and 1536 pin patterns.

17. The system of claim 15 wherein said hybrid substrate is formed of a glass substrate portion attachable to a plastic support portion.

18. The system of claim 17 wherein said glass substrate portion and said plastic support portion are attachable each to the other by adhesive.

19. The system of claim 18 wherein said adhesive is able to withstand acidic and basic assay conditions as well as temperatures from about 0-100 degrees C. without failing.

20. The system of claim 15 wherein said hybrid substrate is formed as 96, 384 or 1536 well micro titer plates that conform to SBS size and shape specifications for robotic handling of micro titer plates.

21. The system of claim 20 wherein said at least one micro array is deposited in at least one of said 96, 384 or 1536 wells of said hybrid substrate by said gridding head.

22. The system of claim 21 wherein a minimum density for a micro array in each said well of a hybrid substrate in 96 well format is about 10×10, an intermediate array density is about 50×50 and a maximum array density is about 75×75, and wherein said micro array may be formed in any density, square or non-square, including and between said minimum density and said maximum density.

23. The system of claim 21 wherein a minimum density for a micro array in each said well of a hybrid micro titer plate substrate in 384 well format is about 5×5, an intermediate array density is about 20×20 and a maximum array density is about 35×35, and wherein said micro array may be formed in any density, square or non-square, including and between said minimum density and said maximum density.

24. The system of claim 21 wherein a minimum density for a micro array in each said well of a hybrid micro titer plate substrate in 1536 well format is about 2×2, an intermediate array density is about 10×10 and a maximum array density is about 20×20, and wherein said micro array may be formed in any density, square or non-square, including and between said minimum density and said maximum density.

25. The system of claim 15 wherein said gridding head comprises: an at least two-layer pin holding device comprised of a lower and an upper plate, wherein said gridding pins pass through said lower plate and are held in place by said lower and upper plates wherein only the tips of said gridding pins protrude below said lower plate.

26. The system of claim 25 wherein at least one spring is disposed between said lower and upper plates, and around each said pin such that the combination of said lower and upper plates and said at least one spring of said gridding head stabilizes said pins and provides flex for consistent deposition of sample when said pins contact said hybrid substrate.

27. The system of claim 25 wherein said lower and said upper plates are formed of metal.

28. The system of claim 15 wherein said array reader comprises:
a light source for exciting a light sensitive material on samples in said at least one micro array;
an inverted microscope to produce an enlarged view of said at least one micro array;
a photomultiplier tube or charge coupled device to amplify a signal generated by said light sensitive material;
a three-dimensioned XYZ-stage positioning device to position said light source and said microscope on a selected region of said hybrid micro titer plate substrate to read each said at least one micro array; and
software capable of real-time data acquisition, processing and analysis to receive, store, and analyze each said signal received by said reader.

29. The array reader of claim 28 wherein said reader is adaptable to read both the conventional microscope slide format of micro arrays and micro arrays contained on said hybrid micro titer plate substrate.
